(19) United States
(12) Patent Application Publication
(10) Pub. No.: US 2026/0299100 A1
(43) Pub. Date: Oct. 1, 2026

(54) METHOD OF CALIBRATION OF AN OPTICAL DETECTION SENSOR AND OPTICAL SENSOR SYSTEM

(71) Applicant: Valeo Detection Systems GmbH, Bietigheim-Bissingen (DE)

(72) Inventors: Sarath Manchala, Bietigheim-Bissingen (DE); Julian Wormer, Bietigheim-Bissingen (DE); Pradeep Shama, Bietigheim-Bissingen (DE); Rachid Alilou, Bietigheim-Bissingen (DE); Urs Zywietz, Bietigheim-Bissingen (DE)

(73) Assignee: Valeo Detection Systems GmbH, Bietigheim-Bissingen (DE)

(21) Appl. No.: 19/489,091

(22) PCT Filed: May 7, 2024
(86) PCT No.: PCT/EP2024/062543

§ 371 Date: Dec. 1, 2025

(30) Foreign Application Priority Data
May 30, 2023 (DE) 102023114062.0

(51) Int. Cl. G01S 7/497; G01S 7/481; G01S 17/931

(52) U.S. Cl. CPC G01S 7/497; G01S 7/4816; G01S 17/931

(57) ABSTRACT

Described is a method for calibration of an optical detection sensor. The method includes successively detecting an optical signal in detection areas of the optical detection sensor, determining respective calibration data for the detection areas, and saving the respective calibration data associated with the detection areas. Also described is an optical sensor system having an optical transmission device and an optical reception device that includes an optical detection sensor.

### FIELD

The present disclosure relates to a method of calibration of an optical detection sensor and an optical sensor system comprising an optical reception device with the optical detection sensor.

### BACKGROUND

Modern vehicles like cars, vans, trucks, motorcycles, etc. may comprise sensor systems, whose data are used for driver information and/or are used by driver assistance systems.

Sensor systems are constantly being developed for various functions, e.g. for the acquisition of environmental information in the near and far range of vehicles, such as passenger cars or commercial vehicles. Based on the acquired data, a model of the vehicle environment can be generated and a reaction to changes in this vehicle environment is possible. Sensor systems can also serve as sensors for driver assistance systems, in particular assistance systems for autonomous or semi-autonomous vehicle control. They can for example be used to detect obstacles and/or other road users in the front, rear or blind spot areas of a vehicle. Sensor systems can be based on different sensor principles, such as radar, ultrasound, optics.

An important optical sensor principle for environment detection, e.g. of vehicles, is the lidar technology (lidar means light detection and ranging). A lidar system comprises an optical transmission device and an optical reception device. The transmission device emits an optical signal, which can be continuous or pulsed. In addition, the optical signal may be modulated. For example, electromagnetic waves in the form of laser beams in the ultraviolet, visual or infrared range may be used as optical signals in a lidar system. The light is received by the optical reception device after reflection from an object in a detection area of the lidar system. The optical signal can for example be evaluated according to a time-of-flight method and the spatial position and distance of the object on which the reflection occurred can be determined. In addition, it may be possible to determine a relative velocity. Reflection or reflected light is understood to mean any light that is reflected back and should also include, in particular, light that is reflected back by scattering or absorption emission.

The lidar system can be designed as a system operating with light flashes, a so-called flash lidar. In this case, the detection area in the environment may be illuminated with a flash of light and the received light reflected from any objects can be detected by the optical reception device.

Scanning lidar systems emit light beams that move in a scanning direction. Point scanners illuminate areas of the environment point by point. Line scanners illuminate areas of the environment line by line.

Optical detection sensors of optical sensor systems may comprise several receiving elements, so-called pixels, and the pixels can be set up to receive light from different receiving angles.

In US20230075080A1 a calibration method for an optical sensor system is described, wherein an emitter and a receiver are calibrated. Received light from a scan of the optical sensor system is recorded with timing information and used for the calibration.

In WO2021228815A1 a method for calibrating and/or adjusting a lidar system is described, wherein a distribution of light incident from the field of view and imaged onto a sensor and a centre position and/or width of the distribution are recorded as position data and are compared with an expected centre position and/or an expected distribution using presumed and/or expected position data.

### SUMMARY

A method of calibration of an optical detection sensor comprises:
successively detecting an optical signal in a plurality of detection areas of the optical detection sensor,
determining respective calibration data for the detection areas,
saving the respective calibration data associated with the detection areas.

The optical detection sensor is comprised an optical reception device of an optical sensor system. The optical sensor system may for example be a lidar system. The optical detection sensor comprises a surface with photosensitive elements which transform received light, i.e. photons, to an electrical quantity like current or voltage. For receiving the optical signal, the optical detection sensor may comprise at least one photodiode, avalanche photodiode, photodiode line or at least one charge-coupled semiconductor component, e.g. a charge-coupled device (CCD). The optical detection sensor may also comprise an active pixel sensor, in particular CMOS sensor, or the like.

The optical sensor system, in particular the lidar system, may further comprise an optical transmission device configured to transmit the optical signal. The optical signal is transmitted into the field of view of the optical sensor system. The optical signal reflected from the field of view may at least partly be received by the optical reception device of the optical sensor system. The sent and received optical signal may then be evaluated to obtain information about the location and/or the object where the reflection occurred. A distance to the point of reflection may be obtained as well as further information about the surface and/or the object on which the reflection occurred. The evaluation of the sent and received light may be performed by a control unit of the optical detection system. The optical sensor system may be employed on vehicles like passenger cars or commercial vehicles to monitor the surroundings of the vehicle.

The calibration relates to the inter-operation of the optical reception device and the optical transmission device. The described method of calibration may for example correct a misalignment of transmission device and reception device of the optical sensor system, in particular lidar system. The misalignment may be due to aging or environmental external influences.

By successively detecting the optical signal in the plurality of detection areas of the optical detection sensor, the respective calibration data for the detection areas may be determined. The calibration data may in particular relate to a received intensity of the received light. By determining the intensity of the received optical signal for the plurality of detection areas, the area the alignment of reception device and transmission device may be judged. By saving the respective calibration data associated with the detection areas, the data may later be used to correct the misalignment and/or to compensate for it.

The detection areas are portions of surface of the optical detection sensor, wherein a detection area may be associated with one or more pieces of calibration data. The partition of the surface into the detection areas allows to obtain the calibration data with a certain spatial granularity with respect to the surface of the optical detection sensor.

In an embodiment of the method, the detection areas partially overlap with each other. This allows to obtain even more refined calibration data, which may also—at least partially—be put into relation with other detection areas.

In an embodiment the method further comprises determining the respective calibration data for a plurality of regions of a plurality of the detection areas. The regions are portions of the detection areas, wherein a region may be associated with one or more pieces of calibration data. The segmentation of the detection areas into regions allows to obtain the calibration data with a certain spatial granularity with respect to the detection area. The respective calibration data associated with the respective region of the respective detection area are then saved to allow for a further use.

In an embodiment of the method, the regions within a detection area are disjoint. This allows for an efficient implementation of the method, covering the respective detection area with few regions.

In an embodiment of the method, the detection areas are of substantially the same shape and/or the regions are of substantially the same shape. In these embodiments, at least some of the detection areas each substantially have the same shape and/or at least some regions each substantially have the same shape. The shape of the regions may be chosen such that the detection areas may be covered by disjoint regions that have the same shape.

The optical detection sensor may comprise pixels for capturing the optical signal. The optical detection sensor may comprise an array with a two-dimensional field of pixels. Pixels of the two-dimensional field can be activated to receive the optical signal, whereby the activation of the pixels may be possible individually and/or in groups. Each detection area and/or each region may comprise a plurality of pixels.

At least one superpixel comprising a plurality of pixels may used for capturing the optical signal. In a superpixel, several pixels are used together for capturing the optical signal and the output electrical signal may be evaluated together.

The pixels or the superpixels of the detection sensor may form an array with a two-dimensional field of pixels or superpixels. At least one detection area may comprise a plurality of columns of pixels or of superpixels. At least one detection area may comprise a two-dimensional array of pixels or superpixels.

The pixels of the detection sensor may form an array with a two-dimensional field of pixels or superpixels. At least one detection area may comprise a two-dimensional array of pixels or superpixels. At least one detection area may comprise a plurality of rows of pixels or superpixels, wherein the respective regions comprise a row of pixels or of superpixels. The at least one detection area may for example comprise a two-dimensional array of pixels and the region may comprise a one-dimensional row of pixels. The at least one detection area may comprise a two-dimensional array of superpixels, and the region may comprise a one-dimensional row of superpixels.

The determination of the calibration data may comprise determining the maximum illumination of the pixels or the superpixels within the respective detection area or within the respective region. The illumination of pixels or superpixels relates to the amount of light that is hitting the surface of the pixel or the superpixel. In this embodiment, the pixel or superpixel with the maximum illumination is determined, i.e. the pixel or superpixel which is hit by the most light. The stored calibration data may depend on this data and/or comprise this data. This allows to compare the maximum illumination of the different pixels or superpixels within the respective detection area and/or the respective region. As a following step, the pixel or superpixel with the maximum illumination within the respective detection area and/or region may be determined.

The calibration data may comprise data depending on the maximum illumination in the respective region and/or the gradient of the maximum illumination in the respective region. In this embodiment it is possible to determine where within the respective region the most light is captured and also how fast and in which direction the illumination is dropping.

In an embodiment of the method the optical signal is transmitted by the optical transmission device to be detected by the respective detection areas. For a scanning lidar system this may comprise successively scanning the detection area such that the optical signal is successively received by the detection areas of the optical detection sensor.

The method of calibration may be executed during production of the optical sensor system and/or during an initialization phase after switching on the optical sensor system and/or during operation of the optical sensor system. During operation the optical sensor system may be mounted on a vehicle and outputting its sensor data to control units of the vehicle, which may use this data to control actors and/or other sensors of the vehicle.

Method according to one of the preceding claims, further comprising applying the calibration data. When applying the calibration data, a misalignment of the optical transmission device and/or optical reception device may be corrected. The method allows to identify the zone of the optical detection sensor, where the main area of reception of the optical signal lies and to calibrate the optical detection sensor accordingly. This allows to take misalignment of the optical transmission device and optical reception device into account. These misalignments may be due to aging over the lifetime of the optical sensor system, optical misalignment due to external impacts, e.g. shocks from the road, people, and/or misalignments due to internal components.

The optical detection system may comprise an optical deflection device to steer the sent light towards the desired portions of the detection area and/or to receive the light from the desired portions of the detection area and steer it towards the reception device. The optical deflection device may for example comprise at least one mirror or at least one optical phased array. The optical deflection device may also be controlled by the control unit of the optical detection system. The optical detection system may be configured to perform the stepwise scan of the field of view. The scan may be performed in a horizontal and/or vertical direction. By applying the calibration data, a misalignment between reception device and deflection device and/or transmission device and deflection device may also be corrected.

The optical sensor system comprises the optical transmission device and the optical reception device. The optical reception device comprises the optical detection sensor. The optical sensor system further comprises the control unit comprising a processor configured to perform the steps of the described method of calibration.

### BRIEF DESCRIPTION OF THE FIGURES

Embodiments will now be described with reference to the attached drawing figures by way of example only. Like reference numerals are used to refer to like elements throughout. The illustrated structures and devices are not necessarily drawn to scale.

FIG. 1 schematically illustrates a method of calibration of an optical detection sensor.

FIG. 2 schematically illustrates a vehicle with an optical sensor system.

FIG. 3 schematically illustrates an optical reception device comprising an optical detection sensor.

FIG. 4 schematically illustrates a superpixel.

FIG. 5 schematically illustrates an optical sensor system with sent and received optical signals.

FIG. 6 schematically illustrates a detection area on the optical detection sensor.

FIGS. 7+8 schematically illustrate an embodiment of the calibration method.

FIG. 9 schematically illustrates an example of an outcome of the method.

### DETAILED DESCRIPTION

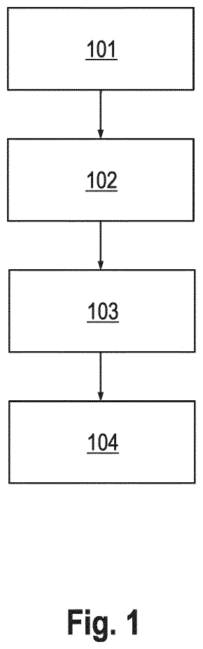

FIG. 1 schematically illustrates a method of calibration of an optical detection sensor 20.

The method comprises:
101: Successively detecting an optical signal L in a plurality of detection areas 22 of the optical detection sensor 20. The detection areas 22 may partially overlap and may in particular overlap for the greater part of their area to allow for a precise calibration.
102: Determining respective calibration data for the detection areas 22. The determination of the calibration data may comprise determining the maximum illumination within the detection area 22.
103: Saving the respective calibration data associated with the detection areas 22. The association of the calibration data and the detection area 22 allows to retrieve respective calibration data which has determined specifically for the associated detection area 22.
104: Applying the calibration data to an optical sensor system 10, in which the optical detection sensor 20 is comprised.

The method may further comprise determining the respective calibration data for a plurality of disjoint regions 24 of a plurality of the detection areas 22 and saving the respective calibration data associated with the respective region 24 of the respective detection area 22.

The optical detection sensor 20 may comprise pixels Px for capturing the optical signal L and a plurality pixels Px may be combined into superpixels SP. In a superpixel SP the plurality of pixels Px comprised in the superpixel SP is used for capturing the optical signal L.

The pixels Px of the detection sensor 20 form an array, wherein the detection areas 22 comprises a plurality of rows of superpixels SP, wherein the respective regions 24 comprise a row of superpixels SP each.

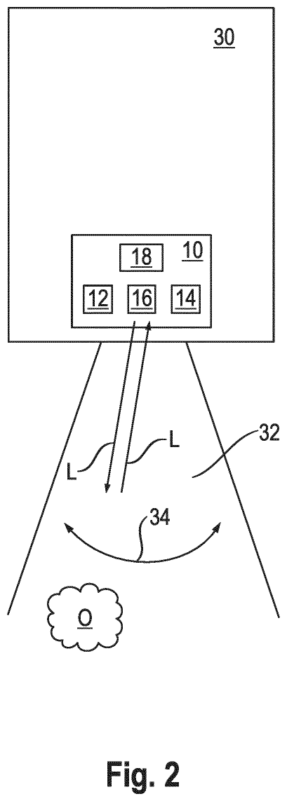

FIG. 2 schematically illustrates a vehicle 30, for example a passenger car. The optical sensor system 10, e.g. a lidar system, is arranged in a front area of the vehicle 30. The optical sensor system 10 comprises the optical transmission device 12, the optical reception device 14, an optical deflection device 16 and a control unit 18.

The optical deflection device 16 may be arranged such that it deflects the light L sent by the optical transmission device 12 into the detection area 32 and deflects the light L incident from the detection area 32 to the optical reception device 14. The optical deflection device 16 may be controlled such that the light L performs a scanning movement 34 over the detection area 32.

In the control unit 18, the transmitted and received optical signals L may be evaluated e.g. using time-of-flight measurements. The evaluation may serve to detect objects O in the detection area 32. The control unit 18 may also monitor and control the transmitting process in the transmission device 12, the receiving process in the reception device 14 and/or the operation of the optical deflection device 16. The control unit 18 may comprise a processor which is configured to perform the steps of the described method of calibration.

The optical sensor system 10 may for example be placed or integrated at the front of the vehicle 30. The detection area 32 is then located in front of the vehicle 30. Thus, in the example shown, an area in front of the vehicle 30 in the direction of travel can be monitored by the optical sensor system 10. There are also optical sensor systems 10 possible for other parts of the vehicle 30, e.g. for surround-view functions such as at the sides and/or rear of the vehicle 30. It is also possible to arrange several sensor systems 10 on the vehicle 30, in particular also in corner areas of the vehicle 30.

The optical sensor system 10 can be used to detect stationary or moving objects O in the detection area 32. Objects O may be vehicles, persons, animals, plants, obstacles, roadway unevenness, in particular potholes or stones, roadway boundaries, traffic signs, open spaces, in particular parking spaces, precipitation, or the like.

The optical sensor system 10 comprising a lidar system may provide an accurate and dense detection point cloud of the detection area that can show the contour of objects O, making it a very valuable sensor for e.g. autonomous or semi-autonomous driving. Mounted in front of the vehicle 30, such a lidar system may e.g. detect lane markings, underrideable elevated objects like tunnels or overhead bridges and the like.

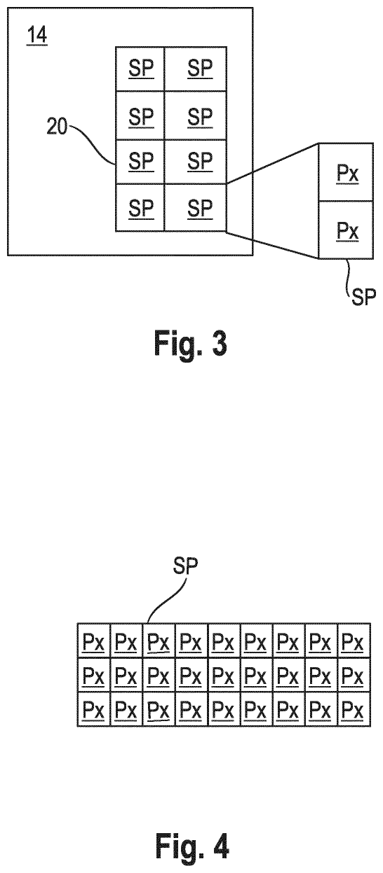

FIG. 3 schematically illustrates the optical reception device comprising the optical detection sensor 20.

The optical detection sensor 20 comprises an array of pixels Px with photosensitive surface. The array of pixels Px is configured to receive light and convert it into an electrical quantity. For this purpose, the respective pixel Px may, for example, have photosensitive elements, e.g. photosensitive semiconductor elements. A respective pixel Px or a respective group of pixels Px of the optical detection sensor 20 can be designed in particular for receiving light from a specific direction. This directional information can also be referred to as angular information, since it indicates the angular direction in space from which the reflection of the received light occurred. From e.g. direction and distance of the place where the reflection took place, a model of the environment of the lidar system can be composed.

A superpixel SP comprises a plurality of pixels Px, e.g. an array of pixels Px. For the superpixel SP, the electrical quantity that is generated by the pixels Px in the superpixel SP in response to the received light is evaluated together. In the embodiment shown in FIG. 3, each superpixel SP comprises two pixels Px. The optical detection sensor 20 comprises an array of superpixels SP.

The superpixel SP comprises an array of pixels Px. The array of pixels Px of the superpixel may have a size of N1×M1 with N1 being the number of rows and M1 being the number of columns. The superpixel SP shown in the embodiment of FIG. 4 comprises an array of 3×9=27 pixels Px with N1=3 and M1=9. Other sizes of superpixels SP are also possible.

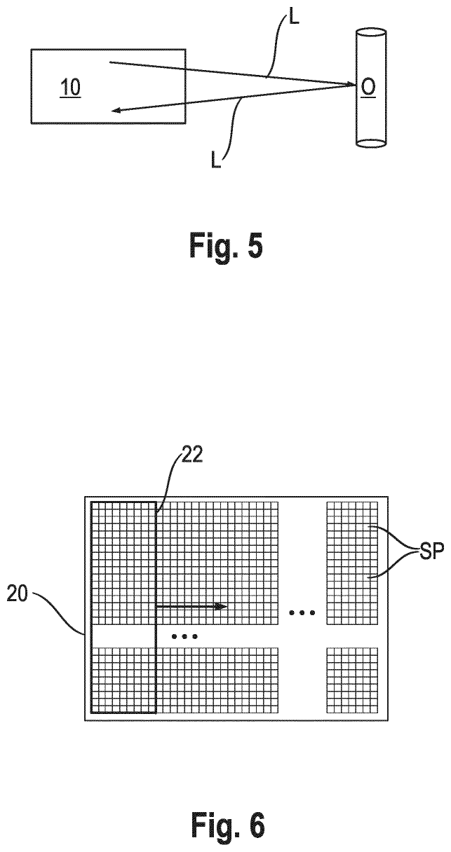

FIG. 5 shows an optical sensor system 10 with sent and received optical signals L. Such a setup may be used for performing the method of calibration, e.g. during production of the optical sensor system 10. The optical transmission device 12 sends the optical signal L, which is reflected by the object O and captured by the optical detection sensor 20. The calibration data can then be obtained by performing the described method of calibration.

In some embodiments, the angle of transmission of the optical signal L may be controlled by the control unit 18 such that the optical signal L may be successively received by the respective detection areas 22.

FIG. 6 schematically illustrates the detection area 22 on the optical detection sensor 20. The optical detection sensor 20 comprises an array of superpixels SP. The detection area 22 comprises an array of superpixels SP. The array of superpixels SP of the detection area 22 is a subset of the whole of the array of superpixels SP that is comprised in the optical detection sensor 20. The arrow in FIG. 6 indicates a direction in which the detection area 22 is successively moved over the optical detection sensor 20. The successive detection areas 22 may be moved to largely overlap. The amount of the movement may be chosen depending on the circumstances and the situation. For example, the detection area 22 may be moved by one column of superpixels SP at a time. Such a movement of the detection area 22 may for example be chosen for a calibration during production of the optical detection system 10 or during an initialization phase after switching on the optical sensor system 10 when starting an operation phase. In other embodiments, the detection area 22 may be moved by three columns of superpixels SP at a time. Such a movement of the detection area 22 may for example be chosen for calibration during operation of the optical sensor system 10.

The determination of the calibration data comprises determining the illumination of the superpixels SP within the respective detection area 22. For each superpixel SP within the detection area 22, the illumination is determined. The stored calibration data depends on the determined maximum illumination within the respective detection area 22. For each respective detection area 22, the associated calibration data may be stored.

From the maximum illumination values a gradient may also be calculated. The gradient gives an indication of the slope including the direction of the slope for the respective maximum illumination. The calibration data may depend on the maximum illumination and/or the slope.

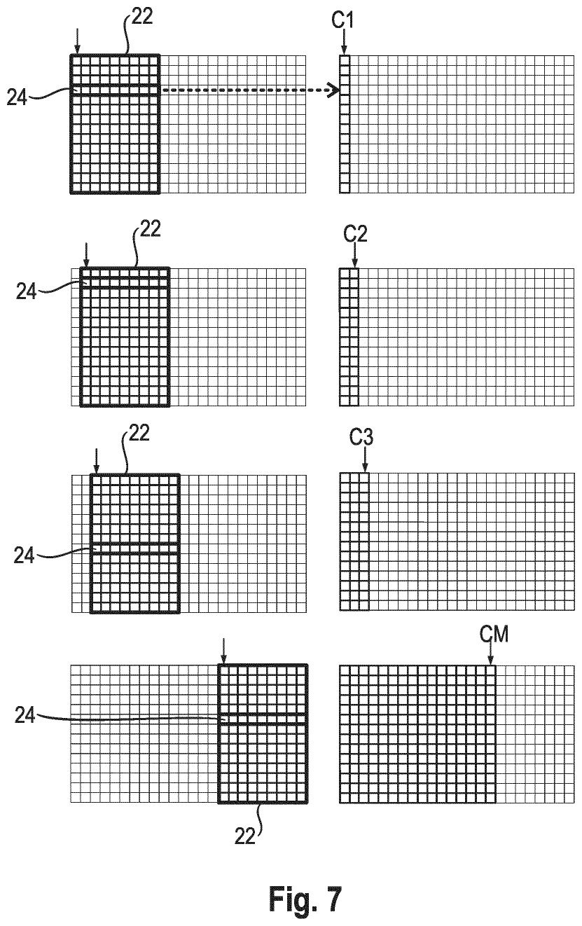

In FIG. 7 an embodiment of the method of calibration is further illustrated. Shown is the array of superpixels SP of an optical detection sensor 20. The detection areas 22 comprise 9 columns of superpixels SP each. The detection area 22 is subdivided into regions 24. In the example shown in FIG. 7, the respective regions 24 are the rows of superpixel SP of the respective detection area 22.

The overall number of columns in FIG. 7 may for example be between 50 and 100, there may in particular be 84 columns.

The determination of the calibration data comprises determining the illumination of the superpixels SP within the respective region 24.

In the example shown in the first line of FIG. 7, the calibration data depends on the maximum illumination of the respective superpixels SP of a respective row of the detection area 22. The respective maximum illumination value for each row is stored associated with the superpixel SP of the respective column C1, C2, C3, . . . , CM of the respective region 24. This concept is visualized with a respective arrow pointing at the columns C1, C2, C3, . . . , CM in the right half of FIG. 7.

The illumination values for the regions 24 may be covered N2 times. In the embodiment shown in FIG. 7, capturing the illumination values for the regions 24 may be repeated 75 times in order to cover e.g. 84 columns at least once. For different sizes of optical detections sensors 20, detection areas 22 and different sizes of superpixels SP, the number of repetitions N2 may be different from 75 and N2 may assume other values. The respective maximum illumination value for the last detection area 22 is stored associated with the column CM, as shown in FIG. 7.

Taking all the maximum illumination values stored associated with the columns C1, C2, C3, . . . , CM the slope including gradient and direction of the illumination of the optical detection sensor 20 may be determined as well.

FIG. 8 schematically illustrates how the method may be implemented on the control unit 18, the optical reception device 14 and the optical detection sensor 20.

A user 80 may initiate the method of calibration in 801, e.g. during production or when starting the optical sensor system 10 for operation or in a service mode. The user may also be a control unit 18 controlling the described method.

In 802, configuration data is received and set by the optical detection sensor 20. In 803 the configuration data is received and set by the control unit 18. The configuration data may include the size of the superpixel SP, e.g. 3×9, the start value for the column and/or the start value for the slope including gradient and direction.

The loop 800 is performed repeatedly to successively capture the detection areas 22, as described with respect to FIG. 7.

In 804, the evaluation of the output of the optical detection sensor 20 is set to the size of the detection area 22 by the optical reception device 14. In 805, the first detection area 22 is captured and in 806 the captured illumination is stored associated with the respective superpixel SP of the first column C1, C2, C3, . . . , CM, as described with respect to FIG. 7. In 807, the next column is set.

In the method, at each identification loop 800, the maximum illumination, which may also be called intensity, within a row is determined with respect to the previous column of the row, so that all maximum intensity values in each row can be identified. From the row for which the highest value for the maximum value is identified and the row where the lowest value for the maximum value is identified, calibration data, e.g. offset values, for the optical detection sensor 20 and slope including gradient and tilt direction can be determined, by estimation. The row for which the highest value for the maximum value is identified and the row where the lowest value for the maximum value is identified, corresponds in the example shown to the highest value in a respective column and the lowest value in a respective column C1, C2, C3, . . . , CM.

At the end of the loop 800, all maximum illumination values in each row may be identified. From the individual maximum illumination values as stored associated with the columns C1, C2, C3, . . . , CM as described with respect to FIG. 7, the slope of the illumination can be estimated.

In 808, the captured data of the loop 800 is output to the user 80 for further processing. For example, the calibration data including the offset values for the optical detection sensor 20, may be obtained by further processing the obtained values.

The described calibration method may address misalignment of the optical transmission device and/or the optical reception device. It may also address misalignment within the optical transmission device and/or within the optical reception device. This may comprise identifying the optimal laser receiving position of a lidar system. The misalignment may be due to optical detection sensor 20 aging and external shocks from tee Environment and road to internal optical components of the optical sensor system 10.

The described method may be applied to different types of lidar systems, including frequency modulated lidar system, e.g. FMCW lidar.

During the operation phase, e.g. when the vehicle 30 is being driven, the successive detection may for example be performed every N3 rows to estimate the possibly minor misalignment due the aging or other environmental disturbances during the operation phase. N3 may for example be 3 in certain embodiments, where the successive detection is performed every 3 rows. N3 may assume other numbers than 3, for example 2 or 4 or more. In other embodiments, the successive detection may be performed every N4 columns, with N4 assuming a value of e.g. 2 or 3 or more.

The method may also be started during the initialization of the optical sensor system 10 or when the optical sensor system 10 is switched on. The successive detection areas 22 may be set to be around N3 rows apart. N3 may for example be 3 in certain embodiments, where the successive detection is performed every 3 rows. N3 may assume other numbers than 3, for example 2 or 4 or more. Such dynamic misalignment function during operation phase of the optical sensor system 10 may confirm if the optical sensor system 10 is still well aligned and in case it is not, where the offsets need to be changed. In other embodiments, the successive detection may be performed every N4 columns, with N4 assuming a value of e.g. 2 or 3 or more.

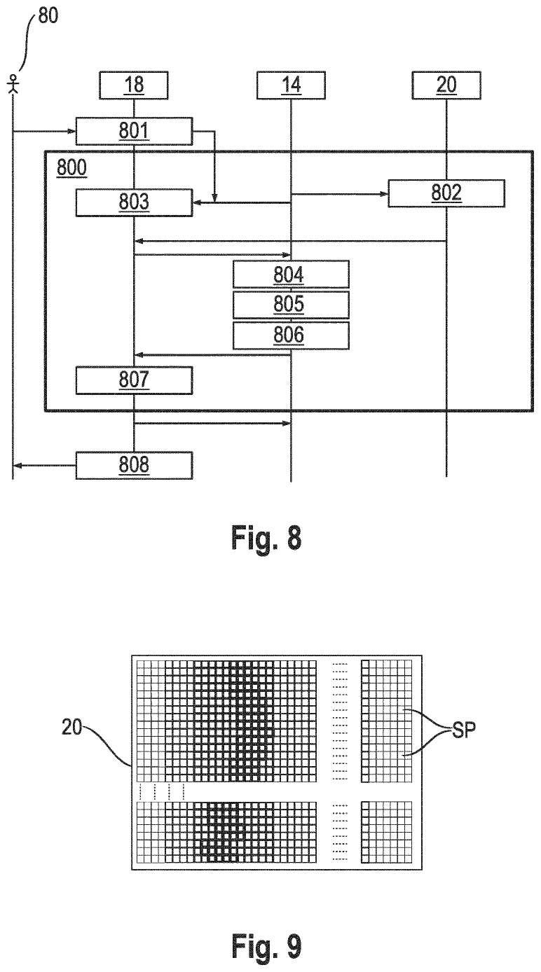

FIG. 9 schematically illustrates an example of an outcome of the method of calibration as described for example in connection with FIG. 8. FIG. 9 illustrates for the optical detection sensor 20 the illumination values for the individual superpixels SP. The bolder framed superpixels SP are the superpixels SP with higher illumination values. The more lightly framed superpixels SP have received less light from the optical signal L. The superpixels SP with the highest received light intensities can be identified and also the slope of the received intensities.

It can be seen that the maximum received intensities are shifted from the middle of the optical detection sensor 20. Also, the horizontal location of the maximum received intensities may vary from row to row.

The optical reception device may be calibrated according to the results of the method of calibration, of which an example of such a result is shown in FIG. 9. The calibration may include adjusting the settings of the optical reception device 14 to take the distribution of received light intensities into account and to improve the reception quality.

1. A method of calibration of an optical detection sensor, the method comprising:
successively detecting an optical signal in a plurality of detection areas of the optical detection sensor;
determining respective calibration data for the plurality of detection areas; and
saving the respective calibration data associated with the detection areas.

2. The method according to claim 1, wherein the plurality of detection areas partially overlap with each other.

3. The method according to claim 1, further comprising:
determining the respective calibration data for a plurality of regions of the plurality of detection areas; and
saving the respective calibration data associated with the respective region of the respective detection area.

4. The method according to claim 3, wherein the plurality of regions within a detection area are disjoint.

5. The method according to claim 1, wherein the plurality of detection areas are of substantially a same shape and/or wherein the plurality of regions are of substantially a same shape.

6. The method according to claim 1, wherein the optical detection sensor comprises pixels for capturing the optical signal, each detection area and/or each region comprising a plurality of pixels.

7. The method according to claim 6, wherein at least one superpixel comprising a plurality of pixels is used for capturing the optical signal.

8. The method according to claim 6, wherein the plurality of pixels or the at least one superpixel of the optical detection sensor form an array, wherein at least one detection area comprises a plurality of columns of pixels or of superpixels.

9. The method according to claim 6, wherein the pixels of the optical detection sensor form an array, wherein at least one detection area comprises a plurality of rows of pixels or superpixels, wherein respective regions comprise a row of pixels or of superpixels.

10. The method according to claim 6, wherein the determination of the respective calibration data comprises determining a maximum illumination of the pixels or the superpixels within a respective detection area or within a respective region.

11. The method according to claim 10, wherein the respective calibration data comprises data depending on the maximum illumination of the pixels in the respective region and/or a gradient of the maximum illumination of the pixels in the respective region.

12. The method according to claim 1, wherein the optical detection sensor is comprised in an optical reception device comprised in an optical sensor system, wherein the optical sensor system further comprises an optical transmission device, wherein the calibration relates to an inter-operation of the optical reception device and the optical transmission device.

13. The method according to claim 12, further comprising transmitting the optical signal by the optical transmission device to be detected by respective detection areas.

14. The method according to claim 12, wherein the method is executed during production of the optical sensor system and/or during an initialization phase after switching on the optical sensor system and/or during operation of the optical sensor system.

15. The method according to claim 1, further comprising applying the calibration data.

16. An optical sensor system comprising an optical transmission device and an optical reception device comprising an optical detection sensor, wherein the optical sensor system further comprises a control unit comprising a processor configured to perform the steps of the method according to claim 1.
